(19) United States
(12) Patent Application Publication
(10) Pub. No.: US 2020/0046584 A1
(43) Pub. Date: Feb. 13, 2020

(54) WHEELCHAIR ARM PAD PROTECTION DEVICE

(71) Applicant: Phoenix HARLEE, Baltimore, MD (US)

(72) Inventor: Phoenix HARLEE, Baltimore, MD (US)

(21) Appl. No.: 16/340,755

(22) PCT Filed: Sep. 1, 2017
(86) PCT No.: PCT/US17/49811

§ 371 Date: Apr. 10, 2019

Related U.S. Application Data
(60) Provisional application No. 62/382,397, filed on Sep. 1, 2016.

(51) Int. Cl. A61G 5/10; A61G 5/12

(52) U.S. Cl. CPC A61G 5/1043; A61G 2203/70; A61G 5/125; A61G 5/1091

(57) ABSTRACT

One aspect of the invention provides a wheelchair armrest cover including: a textile, polymeric, or elastomeric sheet sized to approximate a wheelchair armrest; and one or more fasteners coupled to the textile, polymeric, or elastomeric sheet. The one or more fasteners are configured to secure the textile, polymeric, or elastomeric sheet over the wheelchair armrest

### CROSS REFERENCE TO RELATED APPLICATIONS

This application claims the priority of U.S. Provisional Patent Application Ser. No. 62/382,397, filed Sep. 1, 2016, the entire contents of which are hereby incorporated in total by reference.

### FIELD OF THE INVENTION

The present invention generally relates to a wheelchair, and in particular provides protection to the wheelchair armrest and user

### BACKGROUND OF THE INVENTION

Arm pads on wheelchair armrests often wear unevenly. Over time, portions of the wheelchair armrest can become worn and frayed. At this point, not only does the armrest not provide the intended cushioning, but it can irritate the skin and snag clothing. Repair or replacement of the armrest can be expensive. Repair or replacement can also take time as such actions are not considered a priority when obtaining insurance confirmation.

In addition, there is a need for further cushioning and support. For example, paralysis causes atrophy of the related musculature. This, in turn, makes the bones prone to extra sensitivity, pressure sores, and other neurological pain sensations

There is, thus, a need for a product that can extend the life of the armrest padding. There is a further need for a product that can protect the user's skin and clothing. There is a still further a need for a product that can provide additional cushion and support for a user's arms.

### SUMMARY OF THE INVENTION

The following presents a simplified summary in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

It is an object of the invention to provide a device to cover varying sized wheelchair armrests and thus extend the life of the armrests.

It is a further object of the invention to provide a device to cover varying sized wheelchair armrests and thus provide protection to a user's skin and clothing.

It is a further object of the invention to provide a device that is aesthetically pleasing, can be obtained in varying colors, styles, and fabrics, and can be designed to appeal to men, women, and children.

It is a further object of the present invention to provide a device that provides additional cushion and support to the user's arms.

It is a further object of the present invention to provide a device that is removable.

It is a further object of the present invention to provide a device that can be removed, washed, and replaced.

It is a further object of the present invention to provide an inexpensive and attractive means of protection to the chair and the user.

It is further object of the present invention to provide a compartment for insertion of heating pads or ice packs.

### BRIEF DESCRIPTION OF THE DRAWINGS

For a more complete understanding of the nature and desired objects of the present invention, reference is made to the following detailed description taken in conjunction with the accompanying drawing figures wherein like reference characters denote corresponding parts throughout the several views.

FIG. 1 provides a top view of a wheelchair arm that is beginning to crack.

FIG. 2 provides a side view of the device of the present invention being applied to a wheelchair arm.

FIG. 3 provides a cutaway view showing the inside elastic of the device.

FIG. 4, Panel A illustrates a rectangular piece of underside material placed on top of a similarly sized rectangular piece of topside material.

FIG. 4, Panel B illustrates folding in preparation for stitching.

FIG. 5, Panel A illustrates a side view of the attached device.

FIG. 5, Panel B illustrates a bottom view of the attached device.

FIG. 5, Panel C illustrates a top view of the attached device.

FIG. 5, Panel D illustrates a front view of the attached device.

FIG. 6 provides a cutaway view showing optional pocket/sleeve.

### DETAILED DESCRIPTION

The device of the present invention is removable and can be sized to fit various wheelchair arms. In at least one embodiment, the wheelchair armrest pads are in a full-length size of about 13¾″×5″×5″ (e.g., about 35 cm×13 cm×13 cm). In at least one embodiment, the wheelchair armrest pads are in a desk size of about 10¾″×5″×5″ (e.g., about 28 cm×13 cm×13 cm). In alternative embodiments different sizes are envisioned such as to accommodate a child-size wheelchair, a sports wheelchair such as for racing, basketball, and the like, or a bariatric wheelchair, amongst others.

The device can be made of multiple fabrics having a range of properties including, but not limited to, softness, water resistance, waterproofness, and the like. In at least one embodiment, the material of the underside will be different from the material of the topside, wherein the underside is defined to be the side adjacent upon placement to the wheelchair arm and wherein the topside during use is the side upon which the user's armrests. In at least one embodiment, the device is washable. In at least one embodiment, elastic is used as a closing element. In at least one embodiment a drawstring is used as a closing element. In at least one embodiment, hook-and-loop fasteners (e.g., available under the VELCRO® trademark from Velcro Industries B.V. of the Netherlands Antilles) is used as a closing element. In at least one embodiment, padding is attached to the underside of the device. In at least one embodiment the device is sized to allow for placement of a cooling device (such as an ice pack) or a heating device (such as a heat pack) on the wheelchair arm prior to applying/installing/attaching the device. In at least one embodiment the device includes an inner sleeve or pocket to allow for the placement of a cooling device or a heating device.

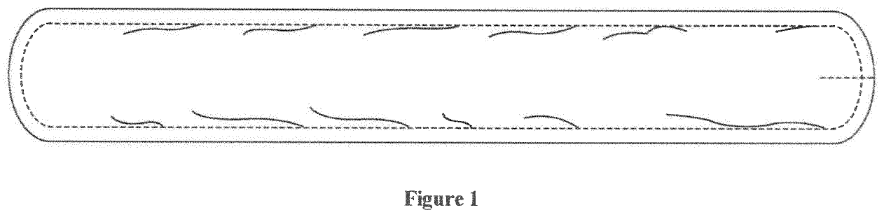

The device may be applied/installed/attached as a preventive measure to preserve the integrity of the wheelchair arms. Similarly, the device may be applied/installed/attached after the wheelchair arms have begun to wear or crack to prevent further damage to the arm and to protect the user's skin and clothing. FIG. 1 depicts a wheelchair arm that has begun to crack.

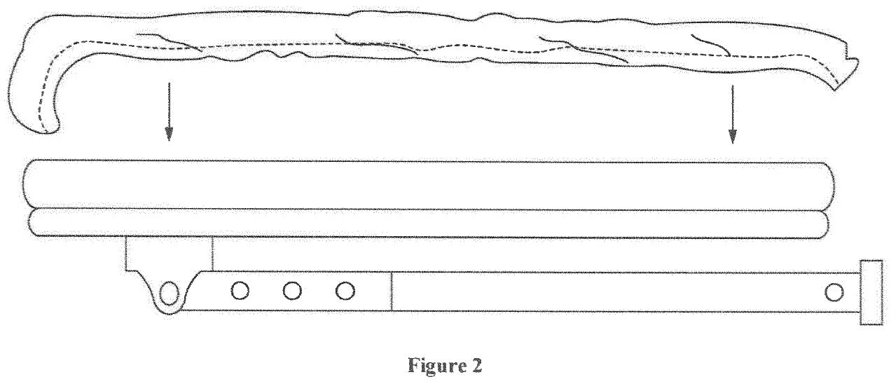

FIG. 2 illustrates application/installation/attachment of the device. As shown, in one embodiment, the device is placed on top of and slightly overlapping the wheelchair arm, such that the wheelchair arm top and sides are covered and a portion of the wheelchair arm bottom is covered. In at least one embodiment where a cooling device or a heating device is also being used, the cooling device or the heating device is placed on the wheelchair arm and the device of the present invention is placed on top of and slightly overlapping both the wheelchair arm and the cooling or heating device, such that the wheelchair arm top and sides are covered and a portion of the wheelchair arm bottom is covered.

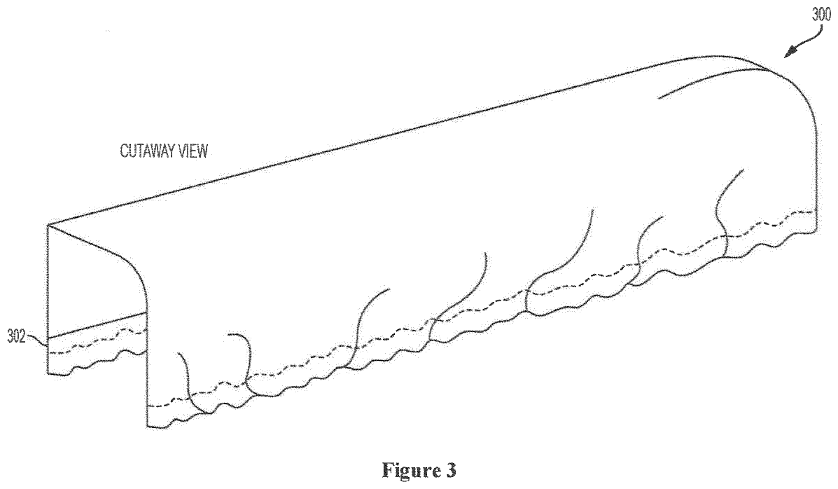

As illustrated in FIG. 3, in at least one embodiment the device is held in place by elastic 302 that has been placed in the perimeter of the device 300, including the front, back and sides. In an alternative embodiment, the device is held in place by one or more hook-and-loop fasteners. In an alternative embodiment, the device is held in place by a drawstring.

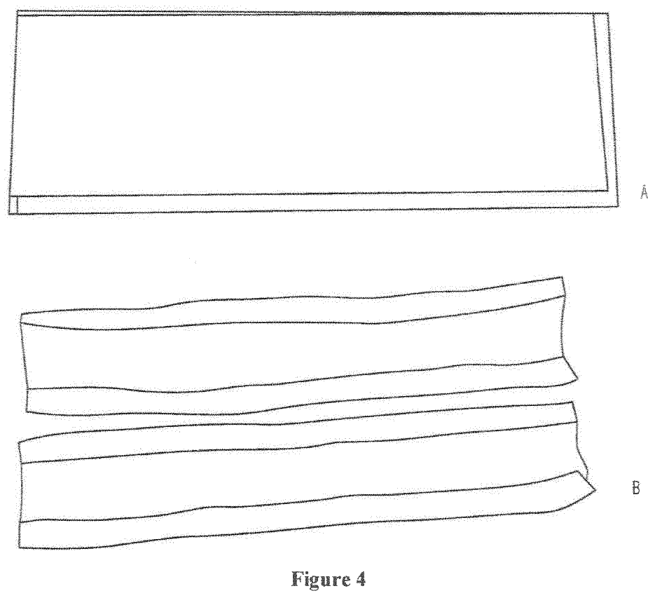

In one manufacturing embodiment, as illustrated in FIG. 4, Panel A, a rectangular piece of underside material is placed on top of a similarly sized rectangular piece of topside material.

As illustrated in FIG. 4, Panel B, a fold is provided on all four sides. The fold can be of adequate depth to allow for insertion of elastic. Edges are then sealed such as by stitching, with an allowance of space between the fold and the seal to allow for insertion of elastic.

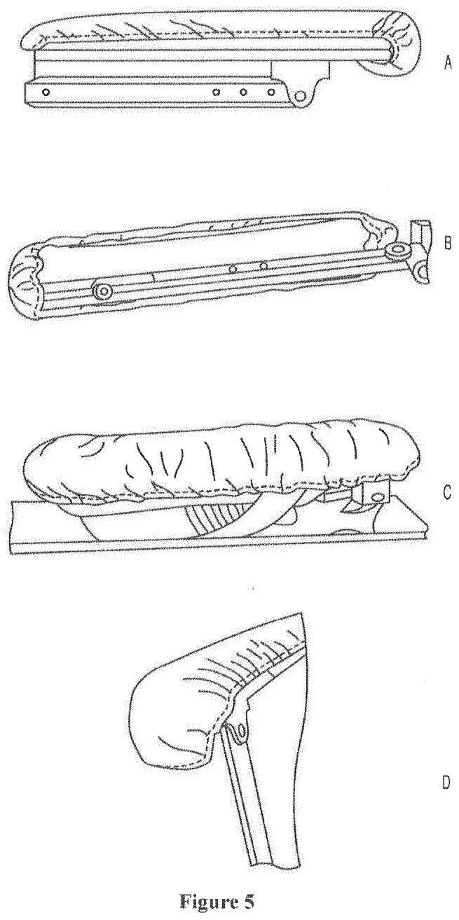

FIG. 5, Panels A-D provide varying views of the elastic applied/installed to a chair arm.

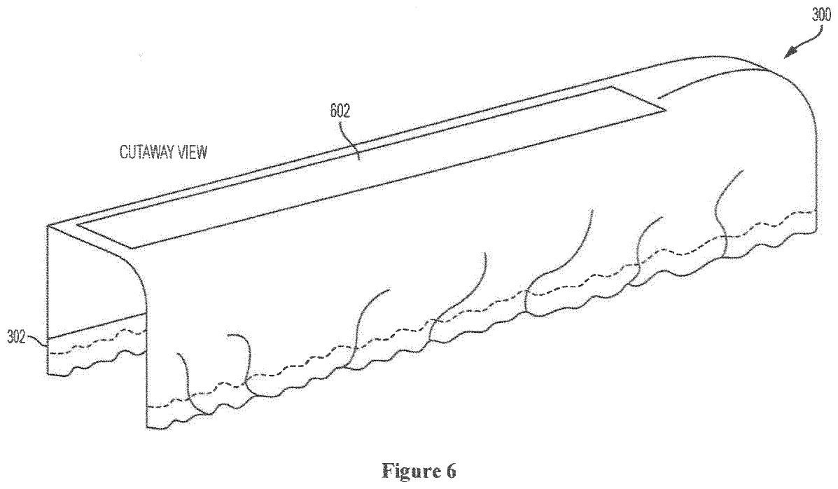

As illustrated in FIG. 6, in alternative embodiments the device includes a pocket or sleeve located such that in application the pocket is within the topside material and sized to house a heating or cooling device.

It is thought that the device of the present invention will be understood from the foregoing description and it will be apparent that various changes may be made in the related protocol thereof without departing from the spirit and scope of the invention or sacrificing all of its material advantages, the form hereinbefore described being merely a preferred or exemplary embodiment thereof.

1. A wheelchair armrest cover comprising:
a textile, polymeric, or elastomeric sheet sized to approximate a wheelchair armrest; and
one or more fasteners coupled to the textile, polymeric, or elastomeric sheet, the one or more fasteners configured to secure the textile, polymeric, or elastomeric sheet over the wheelchair armrest.

2. The wheelchair armrest cover of claim 1, wherein the textile, polymeric, or elastomeric sheet has a dimension of about 35 cm×13 cm.

3. The wheelchair armrest cover of claim 1, wherein the textile, polymeric, or elastomeric sheet has a dimension of about 35 cm×13 cm×13 cm.

4. The wheelchair armrest cover of claim 1, wherein the one or more fasteners include an elastic band located around the perimeter of the textile, polymeric, or elastomeric sheet.

5. The wheelchair armrest cover of claim 1, wherein the one or more fasteners include one or more hook-and-loop fasteners.

6. The wheelchair armrest cover of claim 1, wherein the one or more fasteners include one or more drawstrings.

7. The wheelchair armrest cover of claim 1, said textile, polymeric, or elastomeric sheet further comprising a pocket.

8. The wheelchair armrest cover of claim 7, further comprising:
a heating device or a cooling device, wherein said heating device or said cooling device is insertable into said pocket.
